(19) United States
(12) Patent Application Publication
(10) Pub. No.: US 2026/0152188 A1
(43) Pub. Date: Jun. 4, 2026

(54) DRIVER ASSISTANCE SYSTEM FOR MOTOR VEHICLES

(71) Applicant: Robert Bosch GmbH, Stuttgart (DE)

(72) Inventors: Andreas Wilmes, Warburg (DE); Deniz Neufeld, Ludwigsburg (DE); Kavitha Avinash Hannikeri, Heilbronn (DE); Oliver Gaertner, Abstatt (DE); Rico Alf Klein, Heilbronn (DE); Udo Schulz, Vaihingen/Enz (DE)

(21) Appl. No.: 19/404,494

(22) Filed: Dec. 1, 2025

(30) Foreign Application Priority Data
Dec. 4, 2024 (DE) 10 2024 211 573.8

(51) Int. Cl. B60W 40/09; B60W 30/14; B60W 30/16; G06N 20/00

(52) U.S. Cl. CPC B60W 40/09; B60W 30/146; B60W 30/16; G06N 20/00; B60W 2420/408; B60W 2554/4042; B60W 2554/802

(57) ABSTRACT

A driver assistance system for motor vehicles. The driver assistance system includes a processor system having inputs for sensor signals, outputs for actuator commands, and a memory in which a set of rules is stored that determine which actuator commands are to be output in certain constellations of sensor signals. A machine learning module is set up to learn at least one of the rules based on observed driver behavior.

### CROSS REFERENCE

The present application claims the benefit under 35 U.S.C. § 119 of Germany Patent Application No. DE 10 2024 211 573.8 filed on Dec. 4, 2024, which is expressly incorporated herein by reference in its entirety.

### FIELD

The present invention relates to a driver assistance system for motor vehicles, including a processor system having inputs for sensor signals, outputs for actuator commands, and a memory in which is stored a set of rules that determine which actuator commands are to be output in certain constellations of sensor signals.

### BACKGROUND INFORMATION

Motor vehicles are increasingly being equipped with driver assistance systems that support the driver in driving the vehicle and relieve the driver of certain control tasks. Examples of assistance functions include speed regulation to a setpoint speed specified by the driver or, if the vehicle has a distance radar, regulation of the distance from a vehicle in front, as well as lane guidance assistants that actively intervene in the steering of the vehicle.

The rules that determine the system behavior are set by the manufacturer of the driver assistance system on the basis of behavioral studies with human drivers and remain unchanged throughout the entire service life of the vehicle. Individualization, i.e., adaptation to specific preferences of the driver, is only possible to a very limited extent. For example, the driver can, in most distance control systems, select within certain limits the desired time gap with respect to the vehicle in front. The driver also often has a choice between a few predefined driving modes, such as sporty, normal or fuel-saving (Eco). Because of the limited options the driver has to influence the system, it is almost impossible to ensure that the system behavior defined by the manufacturer fully meets the driver's expectations, wishes, and preferences. This has a negative effect on the acceptance of the driver assistance system. The driver will often intervene in the speed or distance control by actively operating the accelerator or brake pedal or by switching the system off completely.

### SUMMARY

An object of the present invention is to provide a driver assistance system with improved acceptance.

This object may be achieved according to the present invention using a driver assistance system having a machine learning module that is configured to learn at least one of the rules on the basis of observed driver behavior.

Sensor signals that the driver assistance system receives from a plurality of vehicle-specific sensors, such as radar sensors, video cameras, lidar sensors, speed and acceleration sensors, yaw rate or steering angle sensors and the like, make it possible for the system not only to perceive the current surroundings, with its objects, weather conditions, traffic situation, and road conditions, but also for it to be usable for tracking the behavior of the human driver, in particular during times when the assistance function is switched off. The machine learning module is therefore active in particular in the phases in which the assistance function is switched off and learns certain stereotypes in the behavior of the human driver and then modifies, within the limits of what is permissible from a safety perspective, the rules specified by the manufacturer in order to adapt the system behavior more closely to the behavior of the human driver. This not only improves acceptance of the driver assistance system and increases customer satisfaction but also simplifies programming of the driver assistance system by the manufacturer, since the machine learning module supplements the behavioral studies customary hitherto and thus makes it possible to limit the scope of these studies.

The system behavior preferred by the driver differs not only from driver to driver but also varies from vehicle type to vehicle type, since characteristics of the vehicle, such as engine power, chassis tuning and the like, also influence the preferred driver behavior. Previously, driver assistance systems had to be adapted by the manufacturer to the particular vehicle type in which the system was to be used. According to the present invention, a larger part of these adaptations can be carried out by the machine learning module, resulting in a cost saving for the manufacturer.

Advantageous example embodiments and developments of the present invention are disclosed herein.

According to an example embodiment of the present invention, the machine learning module can be a neural network that receives sensor signals in the input layer and outputs actuator commands in the output layer.

In another example embodiment of the present invention, a rule-based algorithm is implemented in the machine learning module. This has the advantage that the scope of the parameters to be learned can be kept within limits and a better predictability of the system behavior is achieved, which is particularly advantageous from a safety point of view.

The hitherto unchangeable set of rules stored in the memory of the driver assistance system can be supplemented by a plurality of variants, each of which defines a slightly modified system behavior, and amongst which the machine learning module can then select the one that exhibits the greatest similarity to the observed behavior of the driver. During the learning phase, the driver is then essentially type-classified, and the rule variant or set of rule variants that best suits the ascertained driver type is selected.

For example, different deceleration strategies can be stored for a distance control function, which determine the necessary deceleration of the ego vehicle when approaching a slower vehicle in front. The deceleration strategy can be specified, for example, by a function that specifies the vehicle deceleration or a correlated quantity such as brake pressure as a function of time or distance. According to an example embodiment of the present invention, during the learning phase, the deceleration strategy used by the driver is recorded and compared with the stored deceleration strategies as part of a similarity search. The similarity search can be performed, for example, for each individual driving maneuver. Ultimately, the strategy chosen is the one that most frequently matches the observed driver behavior. Alternatively, averaging is performed over the strategies recorded for a plurality of driving maneuvers, and the similarity search is performed on the averaged strategy.

Analogously, such a similarity search can also be carried out for other assistance functions, for example to adapt the desired distance during following driving to the habits of the driver, to adapt the acceleration behavior when switching from following driving to free driving, or, in the case of route guidance by means of a navigation system, to adapt the speed profile to the course of the road and any turning-off maneuvers.

The present invention is explained in more detail below with reference to an exemplary embodiment.

### BRIEF DESCRIPTION OF THE DRAWINGS

FIG. 1 is a block diagram of a driver assistance system according to an example embodiment of the present invention.

FIG. 2 shows examples of deceleration strategies when approaching a slower vehicle in front.

FIG. 3 shows an example of a possible categorization of sensor signals.

FIG. 4 shows an example of a constellation matrix based on the categorization according to FIG. 3.

FIG. 5 illustrates with the aid of a flow chart the mode of operation of the driver assistance system, according to an example embodiment of the present invention.

### DETAILED DESCRIPTION OF EXAMPLE EMBODIMENTS

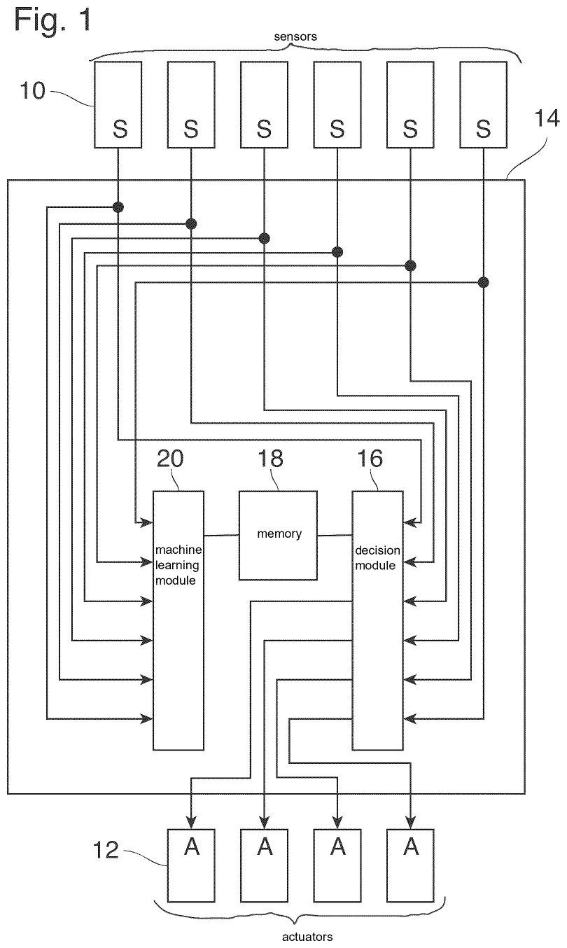

The driver assistance system shown in FIG. 1 comprises a number of sensors 10, a number of actuators 12, and a processor system 14 that receives sensor signals S from the sensors 10 and outputs actuator commands A to the actuators 12. The sensors 10 are sensors such as radar sensors, video cameras, lidar sensors or ultrasonic sensors that collect data about the surroundings of the vehicle, as well as sensors such as speed sensors, acceleration sensors and the like that collect data about the driving dynamics and/or the vehicle itself and, optionally, also about the driver. In practice, the number of sensors is generally much greater than in the simplified example shown here. The actuators 12 are units that act on the drive system, the braking system and, optionally, the steering of the vehicle and are comparable in function to the action of an accelerator pedal, a brake pedal and, optionally, a recuperation unit. If the driver assistance system also has a lane-keeping function, there are additional actuators for steering intervention.

The processor system 14 contains a decision module 16 that receives the sensor signals S from the sensors 10 at its inputs and calculates the actuator instructions A for the actuators 12 according to a system of rules that are stored in a memory 18.

Furthermore, the processor system 14 contains a machine learning module 20 that likewise receives the sensor signals S from the sensors 10 at its inputs and uses these signals to track the behavior of the human driver. For example, the machine learning module 20 can determine whether and how the driver brakes or accelerates or operates the steering wheel. The memory 18 contains a plurality of slightly different closed-loop or open-loop control strategies for at least one assistance function of the driver assistance system, of which only one is made available to the decision module 16. The machine learning module 20 compares the observed driver behavior with the stored closed-loop or open-loop control strategies and selects the strategy that is most similar to the driver behavior. In this way, the system learns the habits and preferences of the driver and adapts the behavior of the decision module 16 to the behavior of the driver within certain limits that do not impair driving safety.

Examples of closed-loop and open-loop control strategies, for which a plurality of variants are available, include specifications for the desired distance to a vehicle in front as a function of speed; acceleration profiles for accelerating the vehicle when its own lane is clear following a lane change by the vehicle in front; and deceleration profiles for decelerating the vehicle when approaching a slower vehicle in front. The mode of functioning of the machine learning module will be explained in more detail below using this last example.

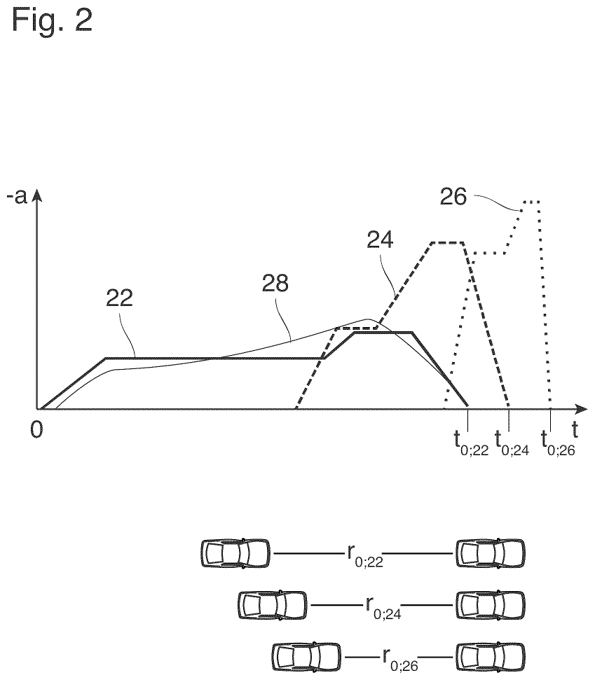

In FIG. 2, three deceleration profiles 22, 24, 26 and their corresponding setpoint distances r_{0;22}, r_{0;24} and r_{0;26} are shown graphically. The deceleration profiles are stored in the memory 18 and each specifies the (negative) setpoint acceleration −a as a function of time t. At the end of the deceleration phase, the ego vehicle should follow the vehicle in front at a constant distance r_{0;22}, r_{0;24} or r_{0;26}. This means that, during the deceleration phase, the speed of the ego vehicle must be reduced from its current value to the absolute speed of the vehicle in front as measured by the radar sensor. For all three deceleration profiles 22, 24, 26, the deceleration phase therefore ends at the respective time t_{0;22}, t_{0;24} or t_{0;26} at which the distance to the vehicle in front has decreased to the respective desired distance r_{0;22}, r_{0;24} or r_{0;26}. If r is the distance to the vehicle in front at the time t=0 at which the vehicle in front is first detected or merges from an adjacent lane into the lane of the ego vehicle, and if vᵣ is the time-dependent speed and r₀ is the desired distance, then t₀=(r−r0)/vᵣ is the time that would elapse until the distance has decreased to r₀. If the ego vehicle maintained its own speed unchanged, this would correspond to an (unrealistic) deceleration profile in which the deceleration would be equal to zero over the entire time interval from 0 to t₀ and would then become infinite at the time t₀ so that the relative speed abruptly drops to zero. For all deceleration profiles, the integral of the setpoint deceleration over the deceleration phase is equal to the relative speed of the vehicles at time t=0. The areas under the three curves that indicate the deceleration profiles 22, 24, 26 are therefore the same for all profiles. The profile 22 corresponds to a defensive manner of driving, in which deceleration begins at the earliest possible time t=0. The profile 24 corresponds to a “normal” manner of driving, in which deceleration begins significantly later but is then stronger, and the profile 26 corresponds to a sporty or “aggressive” manner of driving, in which deceleration starts even later and braking is correspondingly stronger. In the example shown, all three profiles are sectionally linear, with a first ramp-up phase in which the deceleration increases linearly, a first holding phase with constant deceleration, a second ramp-up phase in which the deceleration again increases linearly but with a different gradient, a second holding phase with constant deceleration, and a ramp-down phase in which the deceleration decreases back to zero. The deceleration profiles can thus be characterized by a comparatively small number of parameters, so that the memory requirement in the memory 18 does not become too large. The deceleration profiles for other relative speeds at time t=0 can be derived from the curves shown in FIG. 2 by scaling the curves on the acceleration axis according to the relevant relative speed.

In FIG. 2, an actual deceleration profile 28 is also shown in thinner lines, representing a driving maneuver performed by the human driver with the assistance function switched off. By forming the scalar product of the actual deceleration profile 28 with the three stored profiles, it is possible to determine which of the three stored profiles has the greatest similarity to the behavior preferred by the driver. In this example, this would be the “defensive” profile 22.

For long-range radar sensors, it may be necessary to take into account that the radar sensor can detect the vehicle in front at a distance at which the human driver cannot yet properly assess the relative speed. In that case, it may be expedient not to use the time of the first detection as the time t=0, but instead the time at which the distance to the vehicle in front has decreased to such an extent that the human driver would also be able to estimate the relative speed.

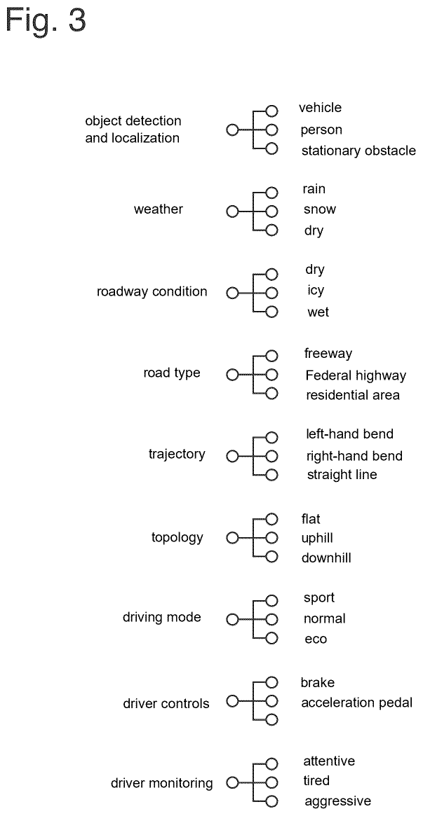

When determining the deceleration profile, the fact that a vehicle in front has been detected, the distance of said vehicle, and the relative speed are certainly the most important influencing factors. However, there may be other influencing factors that affect the behavior of a human driver. For example, a human driver will react differently if the detected object is not a vehicle in front but instead a person crossing the road or even a stationary obstacle on the roadway. FIG. 3 shows, by way of example, nine influencing factors that can affect the behavior of the driver when determining the deceleration profile and that can each have up to three different attributes. Each attribute corresponds to a specific combination and/or evaluation of sensor signals S.

The first influencing factor is the aforementioned object recognition and localization with the attributes “vehicle,” “person” and “stationary obstacle.” A further influencing factor is the weather with the attributes “rain,” “snow” and “dry.” A further influencing factor is the roadway condition with the attributes “dry,” “icy” and “wet.” An influencing factor, “road type,” has the attributes “freeway,” “federal highway” and “residential area.” An influencing factor, “trajectory,” has the attributes “left-hand bend,” “right-hand bend” and “straight.” An influencing factor, “topology,” has the attributes “flat,” “uphill,” and “downhill.” An influencing factor, “driving mode,” has the attributes “sport,” “normal” and “eco.” For example, if the driver switches from “eco” mode to “sport” mode, it can be expected that the driver would also prefer a rather sporty profile when determining the deceleration profile.

A further influencing factor concerns the driver controls with the attributes “brake” and “accelerator pedal.” The third attribute for this factor is unassigned. This factor distinguishes whether the driver tends to achieve the necessary deceleration for as long as possible by releasing the accelerator pedal (engine braking) or whether he tends to apply the brake pedal early on. In vehicles having an electric drive, a similar influencing factor may be added, which distinguishes which recuperation strategy the driver has selected.

Finally, an influencing factor referred to as “driver monitoring” with the attributes “attentive,” “tired” and “aggressive” can also be relevant. These attributes can be determined, for example, by means of electronic image recognition based on the frequency of eye blinking or similar methods. With this influencing factor the deceleration profile can be adapted to the current mood of the driver.

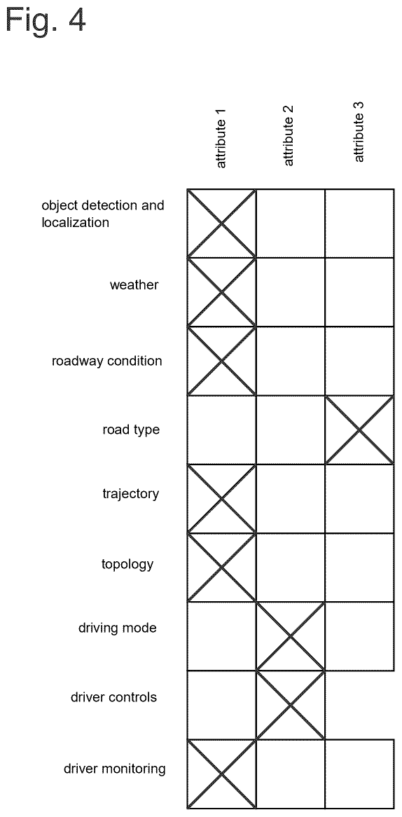

FIG. 4 shows the three exemplary attributes of each of the aforementioned influencing factors in the form of a constellation matrix. Each row of this matrix represents one of the influencing factors, and the three columns represent the three attributes. The crosses in the matrix cells indicate which attribute is currently valid. The example shown represents a constellation in which the detected object is a car (attribute 1), it is neither raining nor snowing, the roadway is dry, the vehicle is in a residential area (attribute 3) and is currently traveling through a left-hand bend and the roadway has no significant incline or decline. The driver has engaged normal mode, tends to use the brake pedal more frequently, and is attentive. Because each influencing factor (with the exception of the driver controls) must have one of three attributes, there are a total of 26 different constellations of influencing factors, and each of these constellations can characteristically change the deceleration behavior of the driver when approaching an obstacle.

However, it may take some time for the machine learning module 20 to learn how these different constellations affect the behavior of the driver. If the driver puts the vehicle into operation in the summer, for example, it will take months to learn how the driver reacts to an icy roadway. For this reason, when the vehicle is put into operation, it may be expedient, in the first learning phases, to initially disregard the influencing factors shown in FIG. 3, with the exception of the first one, and to make the selection of the deceleration profile dependent solely on the actual deceleration profiles 28 recorded during the corresponding driving maneuvers. In this case, averaging may be performed over the curves that are recorded over time during a plurality of comparable driving maneuvers. Once the averaged curve has reached a certain degree of stability, it is compared with the three stored deceleration profiles, and the profile having the greatest similarity is selected. In later learning phases, the selection can then be refined by observing the behavior of the driver in the different constellations of influencing factors. If, in a particular constellation, the driver exhibits a clear preference for a different deceleration profile, this different profile is selected in driver assistance mode when the relevant constellation is present, whereas, in other constellations, the originally selected profile is retained. In this way, a selection can gradually be made for all 26 possible constellations that best corresponds to the preferences of the driver in the situation in question.

If the assistance function is active, the attributes of the influencing factors are determined by means of the vehicle sensors and associated software functions, and the corresponding stored constellation matrix with the associated deceleration profile and/or acceleration profile and/or learned speed-dependent setpoint distance, learned during the learning phase by means of similarity search, is searched for and selected.

In addition to disregarding, during learning, attributes of influencing factors that have not yet occurred or been detected, i.e. manual braking and/or acceleration and/or driving at a speed-dependent distance, it is alternatively possible for constellations not yet learned to be used, when the assistance function is active, by temporarily using a standard deceleration profile and/or standard acceleration profile and/or speed-dependent standard distance (as is the case today) until the complete constellations have been learned.

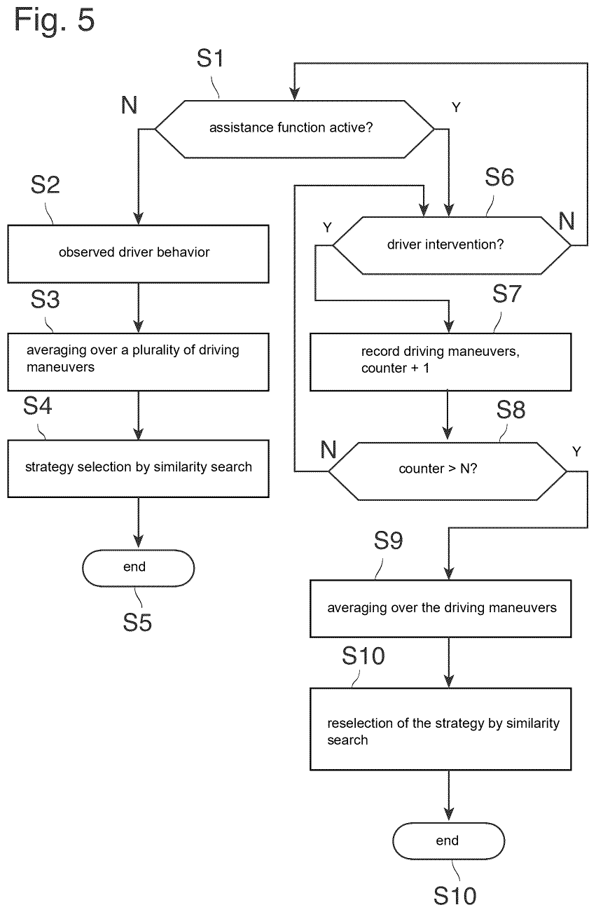

FIG. 5 illustrates in a flow chart the mode of operation of the machine learning module 20 using the example of deceleration.

In step S1, it is checked whether the assistance function is active or not. If the assistance function is switched off (N), a learning phase is initiated or resumed in step S2. In this step S2, the behavior of the driver is observed and, for each driving maneuver in which the driver adjusts the speed to that of a vehicle in front, an actual deceleration curve is recorded and assigned to the corresponding constellation of the specific attributes of the influencing factors of the relevant constellation matrix (one of, for example, 26). In step S3, averaging is then performed over the curves recorded over time. This can also be done by means of a moving average calculation, which reduces memory requirements.

It is understood that the execution of steps S2 and S3 is interrupted if the driver activates the assistance function. If this happens, or if a sufficient number of actual deceleration profiles of the corresponding constellation of the specific attributes of the influencing factors of the relevant constellation matrix have been recorded, in step S4 the deceleration profile is selected by performing a similarity search, assigned to the relevant constellation matrix and stored, which deceleration profile is to be applied when executing the assistance function, and in step S5 the learning mode is ended.

If, in step S1, it is determined that the assistance function is active (Y), then, during operation of the assistance function, a check is performed in a cyclically repeated step S6 as to whether the driver intervenes in the process by pressing the brake pedal or the accelerator pedal. If the driver intervenes (Y), in step S7 the driving maneuver performed with the participation of the driver is recorded, and the number of driver interventions since activation of the assistance function is counted using a counter. The counter is assigned to the corresponding constellation of the specific attributes of the influencing factors of the relevant constellation matrix. In step S8, it is then checked whether the frequency of driver interventions has exceeded a certain value N. As long as this is not the case, steps S6 to S8 are repeated. If the value N is exceeded (Y), in step S9 averaging is performed over the recorded driving maneuvers, and in step S10 a new similarity search is performed. If it turns out that the averaged profile is more similar to another of the deceleration profiles 22, 24, 26 than to the profile used so far, the selection is changed accordingly by assigning and storing the corresponding constellation of the specific attributes of the influencing factors of the relevant constellation matrix of this profile in order to take into account the driver request as discernible from the driver interventions. The program then ends with step S11.

Alternatively, the program can continue with step S2 if the driver switches off the assistance function. It may also be expedient to restart the program with step S1 the next time the driver puts the vehicle into operation. This makes it possible to take into account influencing factors for which some attributes appear only after a longer period of time.

If the vehicle is used by a plurality of drivers, the identity of the driver can be determined, for example, on the basis of an encoding of his key and/or by means of facial recognition by the driver monitoring camera, so that the system behavior can be adapted individually for each driver.

If the machine learning module does not include a rule-based algorithm, i.e. if it is, for example, a neural network and/or transformer, etc., then there will be no constellation matrix. This means, for example, that the neural network itself determines the correlations between attributes of the influencing factors and the deceleration behavior. Furthermore, it is possible that the neural network itself determines the attributes/characteristics that are relevant for the deceleration behavior. It is possible to place the vehicle into (initial) operation with an off-line pre-trained neural network and, during operation, to further train/adapt the model online in a driver-specific manner during manual braking.

To detect incorrect learning and avoid safety-critical situations, the deceleration curve and speed-dependent distance determined by the neural network can be compared with a standard deceleration curve and a standard speed-dependent distance with respect to feasible and sufficient deceleration and speed-dependent distance in that, for example, as explained above, the parameters are at all realizable by the braking system and the areas under the curves, i.e. the integral of the setpoint decelerations (the output of the neural network being a setpoint profile and likewise the conventionally calculated standard setpoint profile), are approximately equal. If not, the conventional standard setpoint profile and standard distance will be used, and the neural network must be further trained or adapted.

The same applies in the case of acceleration.

What is claimed is:

1. A driver assistance system for a motor vehicle, comprising:
a processor system including inputs for sensor signals, outputs for actuator commands, and a memory in which a set of rules is stored that determine which actuator commands are to be output in certain constellations of sensor signals;
wherein the processor system further includes a machine learning module that is configured to learn at least one of the rules based on observed driver behavior.

2. The driver assistance system according to claim 1, wherein a rule-based learning algorithm is implemented in the machine learning module.

3. The driver assistance system according to claim 2, wherein a plurality of mutually interchangeable and different rules are stored for each type of driving maneuver for which rule learning by the rule-based learning algorithm is provided, and wherein, for execution of an assistance function, the machine learning module selects a rule of the plurality of rules that has a greatest similarity to the observed driver behavior.

4. The driver assistance system according to claim 3, wherein the driving maneuver is an adjustment of a speed of an ego vehicle to a speed of a slower vehicle in front, and the rules of the plurality of rules available for selection characterize different deceleration profiles.

5. The driver assistance system according to claim 3, wherein the driving maneuver is a following driving at a constant desired distance to a vehicle in front, and the rules of the plurality of rules available for selection characterize different degrees of dependency of a setpoint distance on a speed.

6. The driver assistance system according to claim 3, wherein the machine learning module is configured to learn different preferences for rules to be selected depending on different constellations of influencing factors.

7. The driver assistance system according to claim 6, wherein each influencing factor of the influencing factors is characterized by a finite number of attributes.
